(19) United States
(12) Patent Application Publication
(10) Pub. No.: US 2021/0106497 A1
(43) Pub. Date: Apr. 15, 2021

(54) PRESS-THROUGH PACKAGING AND STRIP PACKAGING AND LAMINATE FOR PRODUCING THE SAME

(71) Applicant: HUHTAMAKI FLEXIBLE PACKAGING GERMANY GMBH & CO. KG, Ronsberg (DE)

(72) Inventors: Romina MALOVIC, Kempten (DE); Andreas GMEINDNER, Obergünzburg (DE); Fabio DAIDONE, Ronsberg (DE)

(21) Appl. No.: 16/630,259

(22) PCT Filed: May 18, 2018
(86) PCT No.: PCT/EP2018/063117

§ 371 Date: Jan. 10, 2020

(30) Foreign Application Priority Data
Jul. 14, 2017 (DE) 10 2017 115 861.8

(51) Int. Cl. A61J 1/03; B32B 3/26; B32B 27/36; B32B 15/20; B32B 27/32; B32B 7/12; B32B 15/085; B32B 15/09

(52) U.S. Cl. CPC A61J 1/035; B32B 3/266; B32B 27/36; B32B 15/20; B32B 27/32; B32B 7/12; B32B 2307/718; B32B 15/09; B32B 2307/412; B32B 2439/80; B32B 2250/03; B32B 2250/04; B32B 2307/514; B32B 15/085

(57) ABSTRACT

Press-through packaging (10) has a front wall (20) and a rear wall (30) which are connected to each other along their longitudinal edges (40) and their transverse edges (50) and define a receiving space (60) for a, preferably solid, in particular one-piece, filling material. The front wall (20) and/or the rear wall (30) of the press-through packaging (10) is/are made from a film or a laminate, and the film or laminate has a, preferably mechanically produced, material weakening (70). Strip packaging (100) includes a plurality of press-through packages (10), and additionally includes a film or a laminate for producing the press-through packaging (10) or the strip packaging (100).

The invention relates to a push-through package according to the preamble of claim 1, a strip package according to the preamble of claim 8, and a film or laminate for manufacturing such a push-through package or such a strip package according to the preamble of claim 9.

Push-through packages have been known for some time, for example for individually packing tablets, chewing gum or other individually packaged one-piece objects. Commonly used for this purpose thus far were so-called push-through packages, for example, which were transparent or opaque in design, and consisted of a combination of a plastic film and an aluminum cover to be opened, which was destroyed while opening the package by pressing the packed object from the opposite side, i.e., from the plastic side of the pack, against the interior side of the aluminum cover, until the latter no longer withstood the exerted pressure and burst open or away from the pack. As a rule, deep-drawn polyvinyl chloride in combination with polyethylene was used as the material for such push-through packages, so as to obtain versatile polyvinyl chloride used in making the packing container, which was then sealed with an aluminum cover. For this purpose, the aluminum cover was coated on one side with a thin sealing layer, for example comprised of polyethylene, which was bonded with the aluminum layer of the aluminum cover by means of a primer or adhesive or some other bonding agent.

Such previously known push-through packages have several disadvantages. For example, opening such known packages requires a significant exertion of force, since the aluminum cover had to be burst, but possessed a high stability, rigidity and puncture resistance owing to its metal structure and its thickness, with the latter being required to generate a stable push-through package according to the previously known structural design.

Another significant disadvantage to these previously known push-through packages further lies in the necessity of an expensive material insert, specifically the use of an aluminum film with a high layer thickness as well as in the fact that use is made of a variety of different materials, such as plastics in combination with aluminum, which are hard to recycle because of their heterogeneity, but also due to the high layer thickness of the aluminum.

In addition, the necessary primer, lacquer or adhesive insert required for bonding the aluminum cover with the plastic container leads to the danger that primer, lacquer or adhesive will migrate into the package and/or toward the packed product, which poses the risk of the packed product becoming contaminated.

The object of the invention is to provide a push-through package while avoiding the aforementioned disadvantages, a strip package manufactured out of several such push-through packages, as well as a film or laminate which can be used to fabricate such a push-through package or a strip package manufactured out of such push-through packages, which can be designed to allow a specifically customized removal of one-piece filling products in a manner safe for children and convenient for seniors using fewer, but ecofriendly materials by comparison to previously known push-through and strip packages.

This object is achieved by a push-through package according to claim 1, a strip package according to claim 8 and a film or laminate for manufacturing such packages according to claim 9.

In particular, the object is achieved by a push-through package with a front and a rear wall, which are joined together along their longitudinal and transverse edges, and define a receiving area for a preferably solid, in particular one-piece, filling material, wherein the front and/or the rear wall of the push-through package consist(s) of a film or a laminate, and the film or the laminate has one, preferably mechanically generated, weakened area.

One essential point of the invention lies in the fact that manufacturing both the front and the rear wall of the push-through package according to the invention involves using a film or a laminate, which has one, preferably mechanically generated, weakened area. In this way, the invention makes it possible to refrain from an expensive aluminum cover, which had thus far been necessary for being able to open push-through packages of the kind known to date. The film used according to the invention or the laminate used according to the invention, which has a weakened area, advantageously makes it possible to replace the previously necessary expensive aluminum cover with a cost-effective film or a cost-effective laminate, which due to the weakened area does not expand when exposed to a pressure exerted from inside of a receiving area without allowing access to the interior of the receiving area, but rather bursts open, so that a packaged filling material can be removed.

The weakened area provided in the laminate used according to the invention is advantageously applied mechanically. This makes it possible to avoid a complicated and expensive perforation of the laminate, for example by means of laser beams, and draw upon common mechanical tools that are often used on conventional unpacking machines anyway, for example strip packaging systems.

Otherwise, let it be noted at this juncture that the terms “film” and “laminate” are used synonymously within the framework of this invention or patent application, unless the disclosure content of the patent application states the opposite or otherwise.

In an embodiment of the invention, the weakened area extends over a central region of the receiving area and/or along at least one section of a boundary of the receiving area that laterally envelops the receiving area. In this way, the invention makes it possible to control how and where the film that seals the receiving area bursts open, so that the direction in which the packed object is pressed out of the receiving area can effectively be controlled. As a result, the initially packaged object can be prevented from being ejected from the push-through package in a controlled and undirected manner when breaking open the film, as had been the case in previously known packages sealed with an aluminum film.

The weakened area here advantageously either extends over a central region of the receiving area, so that the pressed-out packaging material comes to lie directly below the package given a horizontally held novel push-through package, or falls directly into the hand of a user through the film gap produced by the pressing out process.

In an alternative embodiment, the weakened area extends along at least one section of a boundary that laterally envelops the receiving area. In this case, the film gap produced by the pressing out process is generated on a corner or an edge of the receiving area, through which the packing material can in turn be specifically removed.

Let it be further mentioned at this juncture that the weakened area can also extend around the edge of the entire receiving area, so that the receiving area is completely opened while pressing out the packaging material, wherein a piece of film that had initially sealed the receiving area is or can be completely removed, or this piece of film now only remains joined to the push-through package along a partial region of the boundary of the receiving area.

In a preferred embodiment of the invention, the film or the laminate is multilayer in design, in particular consisting of 3 or 4 layers, and has a plastic layer preferably made out of polyethylene terephthalate as the stiffest, stabilizing layer.

In addition, an important point of the invention lies in the fact that only this stiffest, stabilizing layer of the film or the laminate has the weakened area, while the remaining layers of the film or the laminate are undamaged and have no weakened area that serves to open the push-through package according to the invention.

According to the invention, the film or the laminate has the layer sequence mentioned below:

(a) polyethylene terephthalate-(c) aluminum-(d) polyethylene or Surlyn;
or
(a) polyethylene terephthalate-(b) polyethylene-(c) aluminum-(d) polyethylene or Surlyn.

According to the invention, the polyethylene terephthalate layer represents the side of the laminate according to the invention that faces away from the packaging material, whereas the polyethylene or Surlyn layer represents the layer of the laminate that faces the packaging material given a finished pack.

In this regard, let it be noted that the polyethylene or Surlyn layer is the layer used to join together the front and rear walls of the push-through package according to the invention via sealing. The resultant important advantage to the invention lies in the fact that, because the two layers, specifically the front and rear wall of the push-through package according to the invention, are sealed, adhesive or lacquer need not be used, which would otherwise be necessary to bond the front wall with the rear wall. As a result, adhesive or lacquer can be prevented from migrating out of the adhesive surfaces and in particular into the package, which otherwise happens in conventional push-through packages, since this type of migration does not arise given a pure seal between two sealing layers. The invention thus reliably and durably prevents the packaging material from becoming contaminated with adhesive or sealing lacquer.

Let it otherwise be noted that the film according to the invention or the laminate according to the invention is manufactured exclusively by extruding and combining the layers, so that a so-called “clean laminate” is involved.

According to the invention, the aluminum layer embedded into the film according to the invention or the laminate according to the invention is very thin in design, and serves only to generate a high-barrier layer, in particular for all climate zones, and is thus continuously arranged over the full surface in both the front wall and the rear wall of the push-through package according to the invention. The aluminum film or the aluminum layer is completely undamaged given a sealed, intact package, and serves as a barrier layer against gases, but does not mechanically stabilize the package according to the invention. While opening the push-through package according to the invention, the aluminum layer along with the remaining layers of the film or the laminate are destroyed by pressing through the packaging material.

In addition, let it be noted that the front wall and the rear wall of the push-through package according to the invention preferably consist of the same respective material, and thus each have the same layer sequence and the same layer thicknesses and application weights for the layers, wherein the latter correspond to the following table:

| | | | | | Especially | |
|---|---|---|---|---|---|---|
| | Layer | | Preferred layer | | preferred layer | |
| | thickness or | | thickness or | | thickness or | |
| | application | | application | | application | |
| Layer | weight | | weight | | weight | |
| (a) Polyethylene | 4-30 | μm | 6-25 | μm | 8-23 | μm |
| terephthalate | | | | | | |
| (b) Polyethylene | 6-16 | g/m² | 7-14 | g/m² | 8-11 | g/m² |
| (c) Aluminum | 4-25 | μm | 5-22 | μm | 6-20 | μm |
| (d) Polyethylene | 6-50 | g/m² | 8-45 | g/m² | 10-40 | g/m² |
| or Surlyn | | | | | | |

In addition, the object according to the invention is also achieved by a strip package, which is composed of a plurality of push-through packages according to the above statements. The push-through packages are here joined together in the longitudinal and/or transverse directions with their respective packing edges, wherein the joining sites can have weakened areas, such as perforations, which can be used to separate the individual push-through packages of the strip package according to the invention.

In another embodiment of the invention, such a strip package according to the invention consists of two adjacent push-through packages and four others arranged in the longitudinal direction relative to each other, which each are detachably bonded together. Let it be noted at this juncture that a strip package according to the invention is not limited to the type of arrangement of individual push-through packages mentioned above; rather, the individual push-through packages can be joined together into respective strip packages in whatever way and number desired.

In addition, the object according to the invention is also achieved by a film or a laminate for manufacturing a push-through package or a strip package according to the respective above statements, wherein the film or the laminate has one of the following respective layer sequences:

(a) polyethylene terephthalate-(c) aluminum-(d) polyethylene or Surlyn;
or
(a) polyethylene terephthalate-(b) polyethylene-(c) aluminum-(d) polyethylene or Surlyn, wherein
the layers of the film or the laminate preferably have the following layer thicknesses or application weights:

| | | | | | Especially | |
|---|---|---|---|---|---|---|
| | Layer | | Preferred layer | | preferred layer | |
| | thickness or | | thickness or | | thickness or | |
| | application | | application | | application | |
| Layer | weight | | weight | | weight | |
| (a) Polyethylene | 4-30 | μm | 6-25 | μm | 8-23 | μm |
| terephthalate | | | | | | |
| (b) Polyethylene | 6-16 | g/m² | 7-14 | g/m² | 8-11 | g/m² |
| (c) Aluminum | 4-25 | μm | 5-22 | μm | 6-20 | μm |
| (d) Polyethylene | 6-50 | g/m² | 8-45 | g/m² | 10-40 | g/m² |
| or Surlyn | | | | | | |

According to the invention, sections of the stiffest, stabilizing layer of the film or the laminate, preferably the polyethylene terephthalate layer, have weakened areas that are spaced apart from each other in such a way that the weakened area(s) extend(s) over a central region of a/each receiving area and/or along at least one section of a boundary of the respective receiving area of the push-through package or the strip package that laterally envelops the respective receiving area during and after the manufacture of the push-through package or strip package, so that the film according to the invention or the laminate according to the invention can be processed into a push-through package according to the invention directly on conventional strip packaging systems.

Summarizing, then, the core of the invention can be described as follows:

The invention provides a novel film, or a novel laminate, which can be used to manufacture a push-through package and/or several push-through packages associated to form a strip package. The push-through package according to the invention enables a precisely adjustable removal of one-piece filling material, and is both safe for children and convenient for seniors to use. In addition, the individual push-through packages joined together into a strip package can be easily and readily separated through the use of a strip packaging technology known in the art. By comparison to previous push-through packages, for example blister packages, a push-through package according to the invention can be manufactured with a reduced and ecofriendly amount of material. In addition, the push-through packages according to the invention can be opened easily and with a low expenditure of force. The push-through package according to the invention has a specific mechanically weakened area on the upper and/or lower film or both films, wherein the weakened area is arranged in about the center of the filling material or on its side given a filled, intact push-through package. The core of the invention lies in pressing the filling material out of the push-through package according to the invention, and thus out of the laminate, or through the laminate. This is accomplished by specifically weakening the outer layer of the composite, i.e., the film or the laminate, without this weakening of the outer laminate layer damaging the barrier layer. One essential advantage to the invention further lies in the fact that the latter can be produced with the use of existing strip packaging systems; furthermore, no additional tools are required for the packing machines. As mentioned above, the upper and lower film are made out of the same material, wherein this material, i.e., the film according to the invention as well as the laminate according to the invention, can be printed on both sides. The push-through strip package is safe for children and convenient for seniors, and also easy to recycle, since only a single material composite is used for manufacturing the push-through package. The ability to separate the individual push-through packages of a strip package can already be incorporated into the material of the push-through package or strip package through a variety of technologies, i.e., no additional equipment is necessary for the packaging systems.

Additional embodiments of the invention may be gleaned from the subclaims.

Let it be noted at this juncture that, in an alternative solution, the aluminum layer or aluminum-containing layer has the aforementioned weakened area, e.g., in the form of a perforation or perforation line. In this case, the layer can naturally no longer serve as a barrier layer. Therefore, it is necessary that at least one of the layers sealed against the aluminum or aluminum-containing layer take over the barrier function. In this regard, reference is made to claims 5 and 6.

In the event that the film or the laminate still has sealing layers, the latter can alternatively also take over the barrier function, as described in claims 12 and 13.

To more easily open the package, at least one of the outer layers according to claim 14 can be oriented in design, i.e., stretched in one direction.

The invention will be described below based upon exemplary embodiments, which are explained in more detail based on the figures. Shown on:

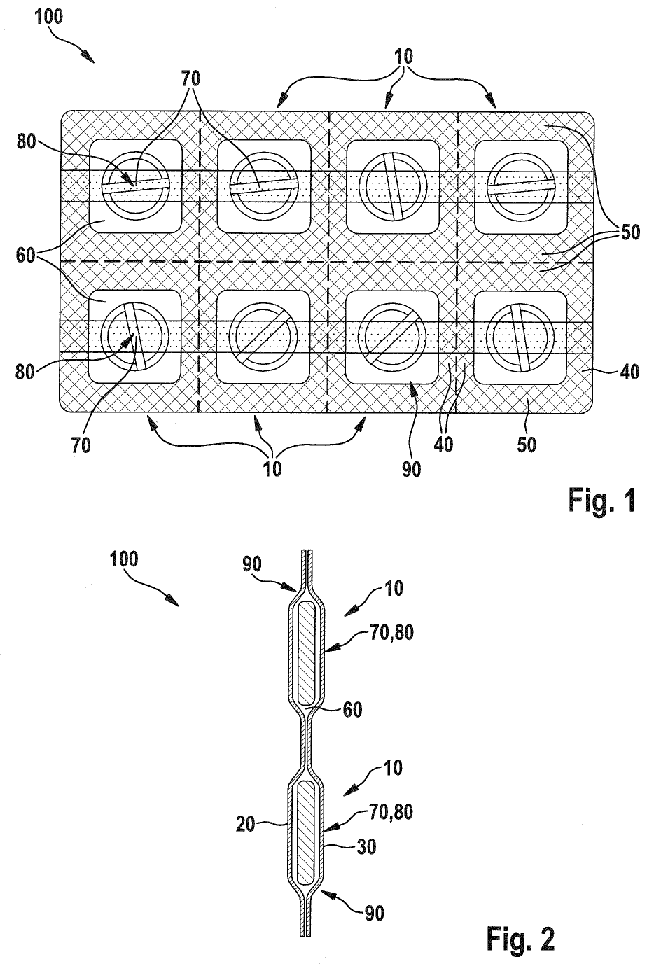

FIG. 1 is a top, schematic view of a strip package according to the invention, which consists of eight individual push-through packages according to the invention;

FIG. 2 is a cross sectional, schematic view of the strip package depicted on FIG. 1;

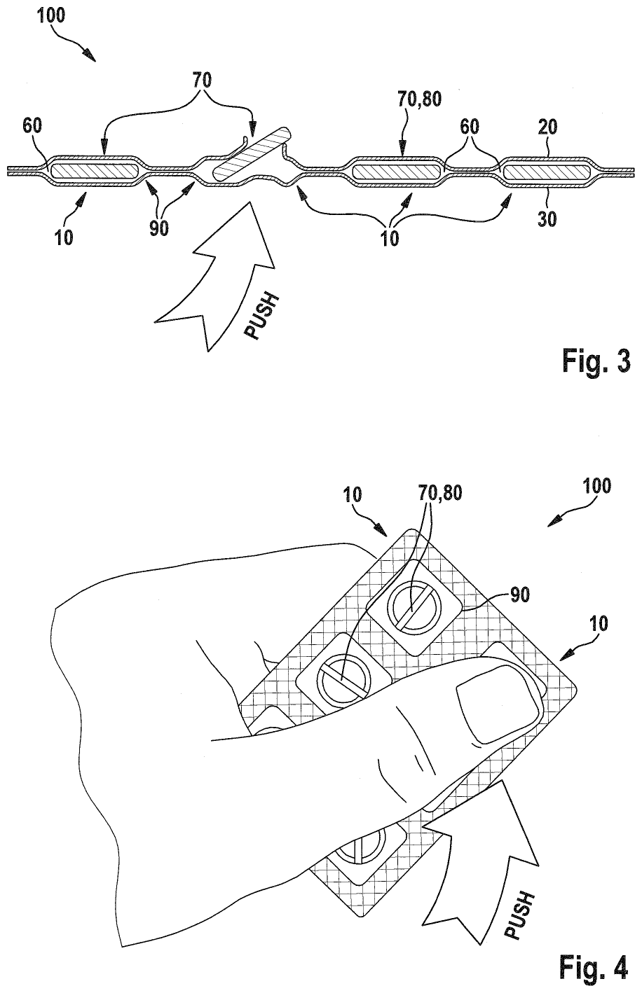

FIG. 3 is a longitudinal sectional, schematic view of the strip package depicted on FIG. 1, illustrating how a one-piece filling material is pressed out of the strip package according to the invention; and

FIG. 4 is another schematic view illustrating how a one-piece filling material is pressed out of the strip package according to the invention.

The same reference numbers are used in the following description for identical and identically acting parts.

FIG. 1 presents a schematic view of a strip package 100 according to the invention, which is composed of a total of eight individual push-through packages 10 in two adjacently arranged rows of four. A respective push-through package 10 has a front wall 20 as well as a rear wall 30, which each are joined together along their long edges 40 and transverse edges 50 in such a way that the push-through package 10 defines a receiving area 60. In each push-through package 10, the outermost layer of the laminate forming the front wall 20 and/or the rear wall 30 has a weakened area 70 that is arranged in a central region 80 of the push-through package 10. According to an alternative embodiment of the invention, the weakened area 70 can also be arranged along a boundary 90 that envelops the receiving area 60. The individual push-through packages 10 are joined together along their respectively facing corners of the long edges 40 or transverse edges 50 in a detachable, i.e., separable, manner.

FIG. 2 presents a schematic view of the strip package depicted on FIG. 1 in a cross sectional view, with it being readily visible how the one-piece filling material is arranged in the respective push-through packages. The same can also be discerned from FIG. 1, since the push-through packages depicted on FIG. 1 are transparently realized in the region of their respective receiving areas 60.

FIG. 3 presents a schematic view of the strip package depicted on FIG. 1 in a longitudinal sectional view, with it being illustrated how a one-piece product is pressed out of the strip package according to the invention. As illustrated on FIG. 3, a pressure is exerted from below on the push-through package according to the invention for this purpose. This is denoted on FIG. 3 by the thick arrow and the word “push”. The pressure on the lower laminate depicted on FIG. 3 that borders the push-through package according to the invention from below transfers a force to the one-piece filling material, which on its part exerts pressure on the push-through package-sealing laminate shown at the top of FIG. 3, so that the upper film initially bulges upwardly, and then bursts open along its weakened area 70, releasing the one-piece filling material.

FIG. 4 shows how such a pressure that causes the push-through package according to the invention to burst open can also be exerted from above on the strip package 100 according to the invention, for example with a thumb, so that the push-through package 10 according to the invention in turn releases the one-piece filling material.

Let it be noted at this juncture that all parts described above are claimed as essential to the invention, whether viewed in isolation or in any combination, in particular the details shown on the drawings. Modifications thereof are familiar to the expert.

### REFERENCE LIST

10 Push-through package
20 Front wall
30 Rear wall
40 Longitudinal edge
50 Transverse edge
60 Receiving area
70 Weakened area
80 Central region
90 Boundary
100 Strip package

1. A push-through package with a front wall and a rear wall, which are joined together along longitudinal edges and transverse edges, and define a receiving area for a preferably solid filling material,
wherein
the front and/or the rear wall of the push-through package comprise a film or a laminate, and the film or the laminate has one weakened area.

2. The package according to claim 1, wherein the weakened area extends over a central region of the receiving area and/or along at least one section of a boundary of the receiving area laterally enveloping the receiving area.

3. The package according to claim 1, wherein the film or the laminate comprises multiple layers and has a plastic layer, as a stiffest, stabilizing layer.

4. The package according to claim 3, wherein only the stiffest, stabilizing layer of the film or the laminate has the weakened area.

5. The package according to claim 1, wherein the film or the laminate has the layer has the following sequence:
(a) polyethylene terephthalate-(c) aluminum-(d) polyethylene or Surlyn;
or
(a) polyethylene terephthalate-(b) polyethylene-(c) aluminum-(d) polyethylene or Surlyn,
wherein at least one of the two sequences is formed against the aluminum layer or an aluminum-containing layer as a barrier layer, if the aluminum layer or aluminum-containing layer is the layer with a weakened area.

6. The package according to claim 5, wherein the film or the laminate has the following layer sequence:
(a) polyethylene terephthalate or similar transparent plastic as the barrier layer-(b) polyethylene either coextruded with the layer (a)-(c) aluminum-(d) polyethylene or Surlyn
or
(a) polyethylene terephthalate or similar transparent plastic as the barrier layer-(b) polyethylene either adhesively bonded or extrusion laminated onto the layer (a)-(c) aluminum-(d) polyethylene or Surlyn.

7. The package according to claim 5,
wherein the layers of the film or the laminate have the following layer thicknesses or application weights:

| | Layer thickness or application weight | |
|---|---|---|
| (a) Polyethylene terephthalate | 4-30 | μm |
| (b) Polyethylene | 6-16 | g/m² |
| (c) Aluminum | 4-25 | μm |
| (d) Polyethylene or Surlyn | 6-50 | g/m² |

8. The package according to claim 1, wherein the front wall and/or the rear wall comprise a same material, and are joined together by sealing.

9. A strip package comprising a plurality of push-through packages according to claim 1.

10. A film or laminate for manufacturing a push-through package according to claim 1,
wherein the film or the laminate has the following layer sequence:
(a) polyethylene terephthalate-(c) aluminum-(d) polyethylene or Surlyn;
or
(a) polyethylene terephthalate-(b) polyethylene-(c) aluminum-(d) polyethylene or Surlyn,
wherein at least one of the two sequences is formed against the aluminum layer or an aluminum-containing layer as a barrier layer, if the aluminum layer or aluminum-containing layer is the layer with a weakened area, wherein
the layers of the film or the laminate have the following layer thicknesses or application weights:

| | Layer thickness or application weight | |
|---|---|---|
| (a) Polyethylene terephthalate | 4-30 | μm |
| (b) Polyethylene | 6-16 | g/m² |
| (c) Aluminum | 4-25 | μm |
| (d) Polyethylene or Surlyn | 6-50 | g/m² |

11. The film or laminate according to claim 10, wherein
the sections of the stiffest, stabilizing layer of the film or the laminate in the polyethylene terephthalate layer, have weakened areas are spaced apart from each other so that the weakened area(s) extend(s) over a central region of a/each receiving area and/or along at least one section of a boundary of the respective receiving area of the push-through package laterally enveloping the respective receiving area during and after manufacture of the push-through package.

12. The film or laminate according to claim 9, wherein the laminate has sealing layers.

13. The film or laminate according to claim 12, wherein the sealing layers are polyolefin layers with barrier coatings.

14. The film or laminate according to claim 10, wherein at least one outer layer comprises an oriented plastic layer.

15. The package according to claim 1,
wherein the front wall and the rear wall define a receiving area for one-piece filling material; and
wherein the film or the laminate has one mechanically generated weakened area.

16. The package according to claim 1; wherein the laminate consists of 3 or 4 layers, and has a plastic layer made out of polyethylene terephthalate as a stiffest, stabilizing layer.

17. The package according to claim 5, wherein the layers of the film or the laminate have the following layer thicknesses or application weights:

| | Layer thickness or Application weight | |
|---|---|---|
| (a) Polyethylene terephthalate | 6-25 | μm |
| (b) Polyethylene | 7-14 | g/m² |
| (c) Aluminum | 5-22 | μm |
| (d) Polyethylene or Syrlyn | 8-45 | g/m². |

18. The package according to claim 5, wherein the layers of the film or the laminate have the following layer thicknesses or application weights:

| | Layer thickness or Application weight | |
|---|---|---|
| (a) Polyethylene terephthalate | 8-23 | μm |
| (b) Polyethylene | 8-11 | g/m² |
| (c) Aluminum | 6-20 | μm |
| (d) Polyethylene or Syrlyn | 10-40 | g/m². |

19. A film or laminate for manufacturing a push-through package according to claim 1,
wherein the film or the laminate has the following layer sequence:
(a) polyethylene terephthalate-(c) aluminum-(d) polyethylene or Surlyn;
or
(b) polyethylene terephthalate-(b) polyethylene-(c) aluminum-(d) polyethylene or Surlyn,
wherein at least one of the two sequences is formed against the aluminum layer or an aluminum-containing layer as a barrier layer, if the aluminum layer or aluminum-containing layer is the layer with a weakened area, wherein
the layers of the film or the laminate have the following layer thicknesses or application weights:

| | Layer thickness or Application weight | |
|---|---|---|
| Polyethylene terephthalate | 6-25 | μm |
| Polyethylene | 7-14 | g/m² |
| Aluminum | 5-22 | μm |
| Polyethylene or Syrlyn | 8-45 | g/m². |

20. A film or laminate for manufacturing a push-through package according to claim 1,
wherein the film or the laminate has the following layer sequence:
(a) polyethylene terephthalate-(c) aluminum-(d) polyethylene or Surlyn;
or
(c) polyethylene terephthalate-(b) polyethylene-(c) aluminum-(d) polyethylene or Surlyn,
wherein at least one of the two sequences is formed against the aluminum layer or an aluminum-containing layer as a barrier layer, if the aluminum layer or aluminum-containing layer is the layer with a weakened area, wherein
the layers of the film or the laminate have the following layer thicknesses or application weights:

| | Layer thickness or Application weight | |
|---|---|---|
| Polyethylene terephthalate | 8-23 | μm |
| Polyethylene | 8-11 | g/m² |
| Aluminum | 6-20 | μm |
| Polyethylene or Syrlyn | 10-40 | g/m². |
